(19) United States
(12) Patent Application Publication
(10) Pub. No.: US 2003/0033340 A1
(43) Pub. Date: Feb. 13, 2003

(54) Power-residue calculating unit concurrently referring to data for concurrent reference

(76) Inventor: Kazuo Asami, Hyogo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/096,883

(22) Filed: Mar. 14, 2002

(30) Foreign Application Priority Data
May 31, 2001 (JP) 2001-163719

(51) Int. Cl. G06F 7/38

(52) U.S. Cl. 708/491; 708/606

(57) ABSTRACT

A power-residue calculating unit includes: a first register group holding a first kind of data; a second register group holding a kind of data to be referred to concurrently with the data held in the first register group; a first internal bus connected to the first register group; a second internal bus connected to the second register group; a Montgomery multiplication residue calculation executing portion connected to the first and second internal buses for concurrently referring to the data held in the first and second register groups and executing a Montgomery multiplication residue calculation; and a power-residue calculation executing portion connected to the first and second internal buses and the Montgomery multiplication residue calculation executing portion for concurrently referring to the data held in the first and second register groups, communicating data with the Montgomery multiplication residue calculation executing portion, and executing a power-residue calculation.

### BACKGROUND OF THE INVENTION

1. Field of the Invention

The present invention relates to power-residue calculating units used for encryption and decryption of information applicable in the fields of telecommunications network, traffic, finance, medical services, distribution and so on. More particularly, the present invention relates to a power-residue calculating unit using a Montgomery algorithm.

2. Description of the Background Art

Owing to the technological development in the field of telecommunication, security (namely, to prevent criminal use or destruction of data) over a communication network has received a great deal of attention. Therefore, encryption and decryption of information are frequently used. The applicable fields of encryption and decryption range from telecommunication to traffic, finance, medical services, distribution and so on. This type of encryption and decryption are required to realize an advanced security based on a simple concept.

To facilitate understanding of this type of technique, a concept of encryption/decryption of information will be briefly described. In the world of encryption, “asymmetric cipher algorithm” is superior. The asymmetric cipher algorithm refers to a cipher algorithm using different encryption and description keys, where one of which cannot be “easily calculated” from the other. An RSA (Rivest-Shamir-Adleman scheme) cipher using a power-residue calculation (a residue is obtained by multiplying a certain number X several times and then dividing the result by another number N) is representative of the asymmetric cipher algorithm.

Basically, the power-residue calculation in accordance with the following formula (1) is used to generate an RSA cipher. Formula (1) means that a residue is obtained by dividing X^{Y} by N. In formula (1), X represents a plaintext to be subjected to encryption (or decryption), where Y and N are keys for encryption (or decryption).

X^{Y}modN (1)

The power-residue calculation facilitates encryption and decryption of information. If the operand bit lengths of X, Y, and N are increased, decryption of each key becomes difficult.

However, the greater operand bit length requires a longer period of time for the power-residue calculation. Then, what is most important is how to reduce the time for the power-residue calculation with a greater operand bit length.

Next, encryption and decryption processes using the power-residue calculation will be described with an RSA cipher by way of example.

[Encryption and Decryption of RSA Cipher]

For decryption of the RSA cipher, the following equation (2) is used.

C=M^{e}modN (2)

For decryption, the following equation (3) is used.

M=C^{d}modN (3)

Here, M represents a plaintext for encryption, and C represents a plaintext which has been subjected to encryption, i.e., a ciphertext. Further, e and N in equation (2) are encryption keys, whereas d and N in equation (3) are decryption keys. Further, the relationship as shown in the following equations (4) and (5) is assumed.

N=p·q (4)

1≡e·dmod{LCM(p−1, q−1)} (5)

Here, “≡” indicates that the left and right sides are similar to each other, and “LCM” is an abbreviation for a least common multiple. Further, p and q are relatively prime integers. Note that e and N are public keys, whereas d, p and q are secret keys.

Equations (4) and (5) both define conditions of numeric values for the power-residue calculation in a cipher algorithm. Equation (4) indicates that N is a product of relatively prime large prime numbers p and q. Since p and q are both odd numbers, N should also be an odd number. Equation (5) indicates that a residue, which is obtained by dividing a product of e and d by a least common multiple of values obtained by subtracting 1 respectively from p and q shown in equation (4), is 1.

Under the conditions specified in equations (4) and (5), plaintext M is encrypted by equation (2), and encrypted plaintext M (ciphertext C) is decrypted by equation (3).

[Method of Power-Residue Calculation]

A method of a power-residue calculation used for encryption/decryption will now be described. The power-residue calculation for A=M^{e}modN is carried out with use of an iterative square product method as shown in the following flow 1 with a binary digit expansion of an integer e being e^{k-1} . . . e¹e⁰.

(Flow 1)

begin

A = 1
for i = k − 1 to 0

begin

| | |
|---|---|
| A = A² mod N | (6) |
| If eⁱ = 1 then A = A · M mod N | (7) |

end

end

A solution of the power-residue calculation would be equal to A.

As described above, the calculation is based on multiplication and division (mod calculation) as shown in equations (6) and (7). The multiplication provides A×A or A×M for a value of A having an initial value of 1. The division provides modN for a value obtained by each multiplication (a calculation of a residue when divided by N). Calculations are iteratively performed in accordance with a bit value of “e” with a pair of “multiplication and division” (A×AmodN, A×MmodN). More specifically, “multiplication and division” is performed in accordance with each bit starting from the most significant bit to the least significant bit of “e”.

As described above, in the power-residue calculation, a solution is obtained by iteratively performing basic residual calculations (mod calculation). The iterative frequency per se is at most several hundreds to several thousands of times, which can be processed by a software at high speed. However, to carry out the residue calculation per se, i.e., division, by a hardware, a large calculation circuit and a complicated process are required, and there have been demand for an improvement. Since large integers of about 1024 bits are usually used for e, d, M, N and so on, even a high-speed exponential calculation still requires multiple precision multiplication and residual calculation of about 1500 times on average per RSA calculation. In particular, various high-speed methods, including an approximation method, residual table method and Montgomery algorithm, have been proposed for the residual calculation.

To increase the speed of the power-residue calculation mostly used for a public key cryptograph representative of the RSA cipher, the speed of one residual calculation must be increased. A Montgomery algorithm provides high speed residual calculation. In particular, in the multiplication residual calculation, division can be simplified by e.g., bit shift. Thus, the power-residue calculation used for a public key cryptograph (e.g., RSA cipher) can be performed at higher speed.

On the other hand, the Chinese remainder theorem states that a calculation modulo a composite number can be carried out by calculations modulo relatively prime factors of the composite number. If this is applied to RSA encryption with 1024-bit length, in practice, only a calculating circuit with a modulus of an integer of a 512-bit length (here corresponding to p and q), rather than a power-residue calculating circuit modulo N of a 1024-bit length, is required as hardware. This contributes to miniaturization of the hardware.

As described above, the size of the calculating circuit disadvantageously increases since the power-residue calculation involves a highly complicated process of basic residue calculation (mod calculation). Then, Montgomery has proposed that a solution can be obtained by “multiplication” and a simple bit-string process, rather than by the above described general method of residual calculation (mod calculation). The method proposed by Montgomery will be briefly described in the following.

[Montgomery Algorithm]

A Montgomery algorithm implementing high speed residual calculation will be described.

The Montgomery algorithm is based on the fact that use of residual modulus N (N>1) and a cardinal number R (R>N) which is relatively prime with respect to residual modulus N allows calculation of TR⁻¹modN to be performed only by division by cardinal number R with a dividend being T. This eliminates the need for division by N for the residual calculation. Here, N, R, R⁻¹ and T are integers. Dividend T satisfies 0≦T<R·N. R⁻¹ is an inverse of cardinal number R according to residual modulus N. Further, consider an integer N′ that satisfies a relation of R·R⁻¹−N·N′=1(0≦R⁻¹<N, 0≦N′<R). Further, if a power of 2 is used for cardinal number R, the division by cardinal number R can be replaced by a shift operation. Thus, a high speed calculation of T→TR⁻¹modN (TR⁻¹modN with a dividend being T) is enabled.

An algorithm MR (T) of T→TR⁻¹modN is given below as algorithm 1. Note that in algorithm 1, (T+m·N)/R has been proved to be always divisable.

(Algorithm 1) Algorithm Y=MR (T) of T→TR⁻¹modN is given by the following sequence.

M=(TmodR)·N′modR (8)

Y=(T+m·N)/R (9)

if Y≧N then Y=Y−N

Y<N then return Y

A single MR provides only TR⁻¹modN rather than a residue TmodN. Thus, to find residue TmodN, an MR calculation is again performed using a product of MR (T) and preliminary found R²modN as shown below.

$$\begin{matrix}MR ( MR ( T ) \cdot ( {R}^{2} mod N ) ) = ( {TR}^{- 1} mod N ) \cdot ( {R}^{2} mod N ) \cdot {R}^{- 1} mod N \\ = {TR}^{- 1} \cdot {R}^{2} \cdot {R}^{- 1} mod N \\ = T mod N\end{matrix}$$

Thus, residue TmodN can be found.

An algorithm implementing the multiplication residue calculation by the Montgomery method using the iterative square product method (iterative square method) of the power-residue calculation is given below. Search is performed starting from an upper bit of key e and, if the bit value of the key is 1, the Montgomery multiplication residual calculation of MR (X·Y) is performed.

Y=Rr (Rr=R²modN (R=2^{k+2}))

X=M

X=MR (X·Y) (10)

Y=MR (1·Y) (11)

for j=k to 1

if eⱼ==1 then Y=MR (X·Y) (12)

if j>1 then Y=MR (X·Y) (13)

end for

Y=MR (1·Y) (14)

Y=YmodN (15)

Here, MR (X·Y) and MR (Y·X) are equal, where eⱼ represents j-th bit of key e. In the case of an integer with 512-bit length, k=512. The power-residue calculation of 512 bits can be implemented by the Montgomery multiplication residue calculation of 514 bits and the residual calculation of 512 bits.

The Montgomery multiplication residual calculation result P=MR (B·A) is found in the following manner by a sequential calculation of a cardinal number W which is most suitable for being implemented as hardware.

W=2^{d}

N0′=N′modW

P=0

for j=0 to k

M=(PmodW)·N0′ (16)

P=((P+(AmodW)·B·W+M·N)/W)mod2^{k} (17)

A=A/W (18)

end

Here, d is a natural number depending on the hardware. Thus, Montgomery multiplication residual calculation result P can be found. Then, 514-bit Montgomery multiplication residual calculation result P=MR (B·A) can be found in the following manner by a sequential calculation of cardinal number 2 where d=1.

N0′=N′mod2

P=0

for j=0 to 514

M=(Pmod2)·N0′ (19)

P=((P+(Amod2)·B·2+M·N)/2)mod2⁵¹⁴ (20)

A=A/2 (21)

end

As described above, to implement the power-residue calculation, a common practice is to use the Montgomery method for the 512-bit length power-residue calculation in the hardware and to use a process making use of the Chinese remainder theorem in the software. There are a plurality of kinds of hardware implementations, which may be employed in practice. An example is shown in the following.

Referring to FIG. 5, a conventional power-residue calculating unit utilizing the Montgomery method includes: an interface circuit 101 for an external bus; an e register 102 holding a key e; a Y register 103 holding a multiplier Y for Montgomery conversion; an N register 104 holding a key N; a B2N register 105 holding a value of 2B+N calculated during Montgomery conversion; an X register 106 holding a plaintext X; a calculating circuit 107 performing calculations for encryption and decryption; a P register 108 holding a calculation result P; and a power-residue control circuit 109 serving as a state machine when a power-residue calculation is executed.

The power-residue calculating circuit further includes: a Montgomery multiplication residue/residue control circuit 110 serving as a state machine when a Montgomery multiplication residue calculation and a residue calculation are executed; an addition/subtraction control circuit 111 controlling calculations of addition and subtraction; a mode register 112 holding various modes; a command register 113 holding a command; a status register 114 holding a status; an internal bus 115 used for data input/output between various registers and calculating circuit 107; and a temporary holding register 119 connected to e register 102, power-residue control circuit 109 and Montgomery multiplication residue/residue control circuit 110 for holding key e temporarily.

In the conventional power-residue calculating unit, each register is connected with a common internal bus 115 to reduce the circuit scale.

Further, when j-th bit value eⱼ of key e is used, j-th bit of key e preliminarily held in temporary holding register 119 is read out. Accordingly, a readout of a value required for Y=MR (X·Y) in equation (12) from a register and a readout of j-th bit of key e can be performed simultaneously. This enables a high speed calculation.

Although the conventional power-residue calculating unit allows for a high speed calculation, it requires excessive interconnection region and register region, resulting in a large scale circuit.

This is also the case with the residue calculation shown in equation (15) or the Montgomery residue calculation shown in equations (10)-(14). Specifically, when a value held in Y register 103 and a value held in N register 104, B2N register 105 or X register 106 are read out alternately, the calculation time is disadvantageously long. On the other hand, when either of the values is preliminarily held in temporary holding register 119 for calculation, a high speed operation is realized, but unfortunately excessive interconnection region and register region are required, resulting in a large scale circuit.

### SUMMARY OF THE INVENTION

The present invention is made to solve the above noted problem, and its object is to provide a power-residue calculating unit realized in a small scale circuit and allowing for a high speed processing.

A power-residue calculating unit in accordance with an aspect of the present invention includes: a first register group holding a first kind of data; a second register group holding a kind of data to be referred to concurrently with the data held in the first register group; a first internal bus connected to the first register group; a second internal bus connected to the second register group; a Montgomery multiplication residue calculation executing portion connected to the first and second internal buses for concurrently referring to the data held in the first and second register groups and executing a Montgomery multiplication residue calculation; and a power-residue calculation executing portion connected to the first and second internal buses and the Montgomery multiplication residue calculation executing portion for concurrently referring to the data held in the first and second register groups, communicating data with the Montgomery multiplication residue calculation executing portion and executing a power-residue calculation.

The data which can be concurrently referred to are separately held in the first and second register groups. When the Montgomery multiplication residue calculation or the power-residue calculation is executed, the data held in the first and second register groups are concurrently referred to. This enables a high speed readout of data and a high speed processing. Further, unlike the conventional one, a temporary holding register is not required, thereby enabling reduction of the circuit scale.

Preferably, the first kind of data held in the first register group is referred to bit by bit. The power-residue calculating unit further includes a one-bit selecting circuit connected to the first internal bus, the Montgomery multiplication residue calculation executing portion and the power-residue calculation executing portion, for acquiring from the internal bus a bit data determined based on a signal supplied from the Montgomery multiplication residue calculation executing portion or the power-residue calculation executing portion, and then supplying the bit data to the Montgomery multiplication residue calculation executing portion or the power-residue calculation executing portion.

Data is read out from the first internal bus bit by bit, rather than from the first register group bit by bit. Generally, the first register group includes a plurality of registers, and therefore, in the absence of the one-bit selecting circuit, each register must be provided with a circuit for acquiring data bit by bit. Provision of the one-bit selecting circuit, however, enables sharing of a circuit for acquiring a bit, which would otherwise be provided for each register. Therefore, it is possible to provide a power-residue calculating unit whose circuit is reduced in size.

More preferably, the Montgomery multiplication residue calculation executing portion has a counter of which a count limit can be changed based on an externally supplied mode signal.

It is possible to change the count limit of the counter based on the mode signal. Therefore, in a test mode, the test time for the Montgomery multiplication residue calculation executing portion can be reduced by decreasing the count limit of the counter.

More preferably, the power-residue calculation executing portion has a counter of which a count limit can be changed based on an externally supplied mode signal.

It is possible to change the count limit of the counter based on the mode signal. Therefore, in a test mode, the test time for the power-residue calculation executing portion can be reduced by decreasing the count limit of the counter.

More preferably, the counter includes a plurality of flip-flops connected in series, and an operation of a part of the plurality of flip-flops stops according to the mode signal.

It is possible to change the count limit by stopping an operation of a part of the flip-flops.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is block diagram showing a hardware structure of a power-residue calculating unit in accordance with a first embodiment of the present invention.

FIG. 2 is a diagram showing a hardware structure of a counter.

FIG. 3 is a timing chart of the signals of the counter.

FIG. 4 is a block diagram showing a hardware structure of a power-residue calculating unit in accordance with a second embodiment of the present invention.

FIG. 5 is a block diagram showing a hardware structure of a conventional power-residue calculating unit utilizing the Montgomery method.

### DESCRIPTION OF THE PREFERRED EMBODIMENTS

(First Embodiment)

(Hardware Structure of Power-Residue Calculating Unit)

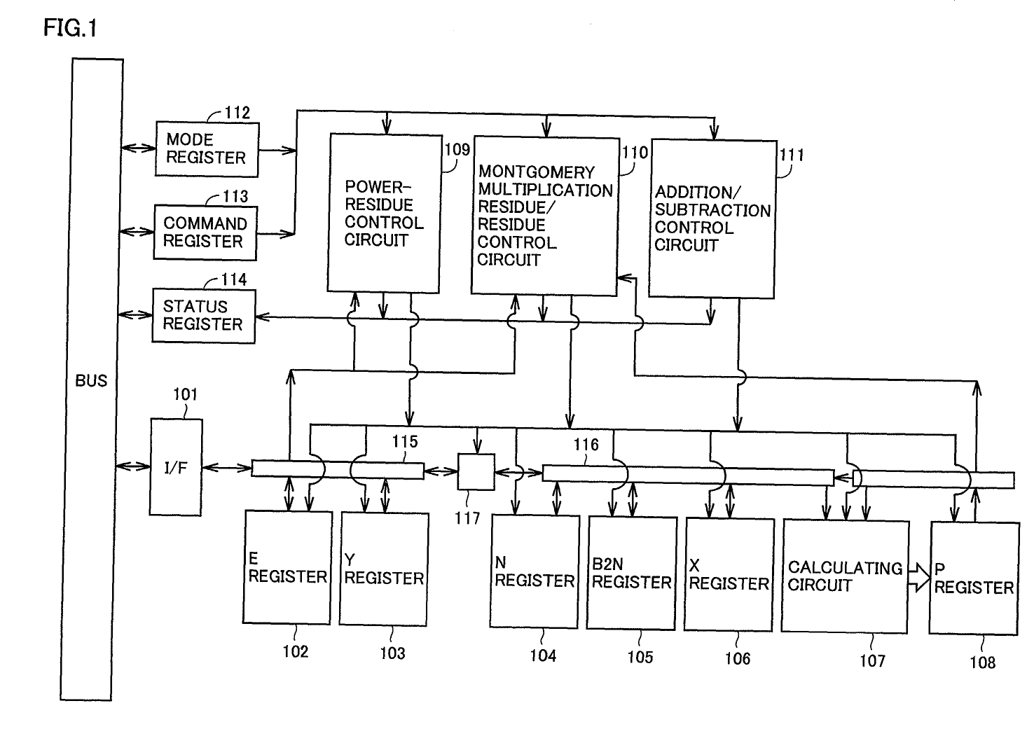

Referring to FIG. 1, a power-residue calculating unit in accordance with a first embodiment of the present invention includes: an I/F (interface) circuit 101 interfacing with an external bus; an e register 102 holding a key e; a Y register 103 holding a multiplier Y for Montgomery conversion; an N register 104 holding a key N; a B2N register 105 holding a value of 2B+N calculated during Montgomery conversion; an X register 106 holding a plaintext X; a calculating circuit 107 performing calculations for encryption and decryption; a P register 108 holding a calculation result; and a power-residue control circuit 109 serving as a state machine when a power-residue calculation is executed.

The power-residue calculating circuit further includes: a Montgomery multiplication residue/residue control circuit 110 serving as a state machine when a Montgomery multiplication residue calculation and a residue calculation are executed; an addition/subtraction control circuit 111 controlling calculations of addition and subtraction; a mode register 112 holding various modes; a command register 113 holding a command; a status register 114 holding a status; an internal bus 115 connected to interface circuit 101, e register 102 and Y register 103 for communicating data between various registers; and an internal bus 116 connected to N register 104, B2N register 105, X register 106, calculating circuit 107, and P register 108 for communicating data between various registers and calculating circuit 107; and a bus dividing circuit 117 connected to internal buses 115 and 116 for controlling data input/output between internal buses 115 and 116.

(Montgomery Calculation Process)

In executing a power-residue calculation, the multiplication residue calculation by the Montgomery method and the residue calculation are used for increasing speed. Among others, a process of a conditional Montgomery calculation [if eⱼ==1 then Y=MR (X·Y)] in equation (12) will be described.

First, for calculating the value of 2B+N, key N is read from N register 104 and held in P register 108 via internal bus 116 and calculating circuit 107. At the same time, key e is read from e register 102, and eⱼ (j-th bit value of key e) is held in power-residue control circuit 109 via internal bus 115.

Next, calculation of 2B+N (here B=X) is executed, the result of which is written into B2N register 105. At the same time, multiplier Y held in Y register 103 is read, and Y₀ (0th-bit value of multiplier Y) is held in Montgomery multiplication residue/residue control circuit 110 via internal bus 115. Y₀ is utilized because in the loop of equations (19)-(21) implementing MR (X·Y) in equation (12), [Amod2] for A corresponding to Y corresponds to 0-th bit of A, that is 0-th bit value of Y.

Based on P₀ (0-th bit value of calculation result P) and Y₀ held in Montgomery multiplication residue/residue control circuit 110, any one of the values held in X register 106, N register 104 and B2N register 105 is read and calculation of equation (20) is executed. At the same time, multiplier Y held in Y register 103 is read out onto internal bus 115, and Y₁ is held in Montgomery residue/residue control circuit 110. Thereafter, calculations of equations (19)-(21) are repeatedly executed. Here, data read from Y register 103 corresponds to A of the Montgomery calculation P=MR (B·A). Therefore, Yⱼ is used in [Amod2] in equation (20) and [A=A/2] in equation (21). In practice, equation (19) requires P0 (if N0′=1), and equation (21) only requires one-bit of Yⱼ.

A similar process is also performed for the residue calculation.

(Calculation Controlling Counter)

A counter is provided within power-residue control circuit 109 shown in FIG. 1. This counter is used for changing the variable j when executing equations (12) and (13).

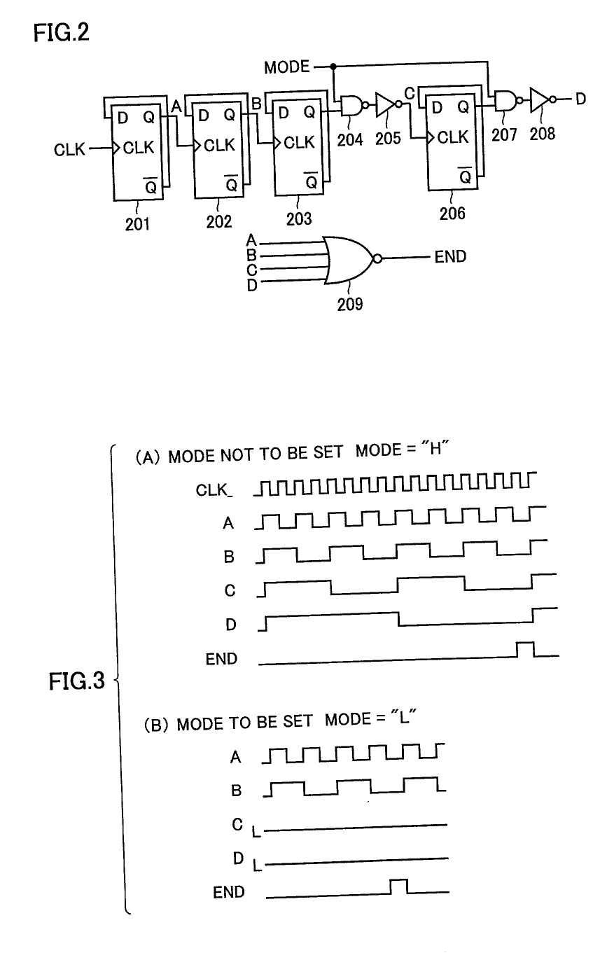

Referring to FIG. 2, the counter includes: a D (Delay) flip-flop 201 having its /Q terminal (/ represents inversion hereinafter) connected to its D terminal; a D flip-flop 202 having its CLK (clock) terminal connected to the Q terminal of D flip-flop 201 and its /Q terminal connected to its D terminal; a D flip-flop 203 having its CLK terminal connected to the Q terminal of D flip-flop 202 and its /Q terminal connected to its D terminal; an NAND gate 204 receiving as inputs a signal output from the Q terminal of D flip-flop 203 and a mode signal; and an inverter 205 receiving an output from NAND gate 204 as an input.

The counter further includes: a D flip-flop 206 having its CLK terminal connected to the output of inverter 205 and its /Q terminal connected to its D terminal; an NAND gate 207 receiving as inputs a signal output from the Q terminal of D flip-flop 206 and a mode signal; an inverter 208 receiving an output from NAND gate 207 as an input; and an NOR gate 209 receiving as inputs the Q terminal of D flip-flop 201, the Q terminal of D flip-flop 202, the output of inverter 205 and the output of inverter 208.

A signal output from the Q terminal of D flip-flop 201, a signal output from the Q terminal of D flip-flop 202, an output signal of inverter 205, and an output signal of inverter 208 are respectively defined as signals A, B, C, and D. An output of NOR gate 209 is defined as a signal END.

The timing chart of each signal when the mode signal is high is shown in FIG. 3A. Specifically, when clock signal is input sixteen times, signal END changes from low to high. This implements the Montgomery multiplication residue calculation when k=16 in the loop of equations (12) and (13).

On the other hand, when the mode signal is low, signals C and D are always low. Thus, the timing chart of each signal is as shown in FIG. 3B. Specifically, when a clock signal is input eight times, signal END changes from low to high. This implements the Montgomery multiplication residue calculation when k=8 in the loop of equations (12) and (13).

In this manner, the loop count can be changed by the mode signal.

A counter similar to the aforementioned counter is also provided in Montgomery multiplication residue/residue control circuit 110. Therefore, the loop count shown in equations (19)-(21) can also be changed by the value of the mode signal.

As described above, in accordance with the present embodiment, an internal bus (internal bus 115) used by Y register 103 and e register 102 and an internal bus (internal bus 116) used by the other registers (N register 104, B2N register 105 and X register 106) are separated. This enables a concurrent readout of data from Y register 103 or e register 102 and N register 104, B2N register 105 or X register 106. Therefore, the Montgomery multiplication residue calculation can be executed at high speed.

Furthermore, a conventional temporary holding register is not required, thereby enabling reduction of the circuit scale.

In addition, the number of times of loop processes can be reduced by the value of the mode signal. Therefore, it becomes possible to perform a test with the reduced number of times of loop processes and to reduce the test time.

(Second Embodiment)

(Hardware Structure of the Power-Residue Calculating Unit)

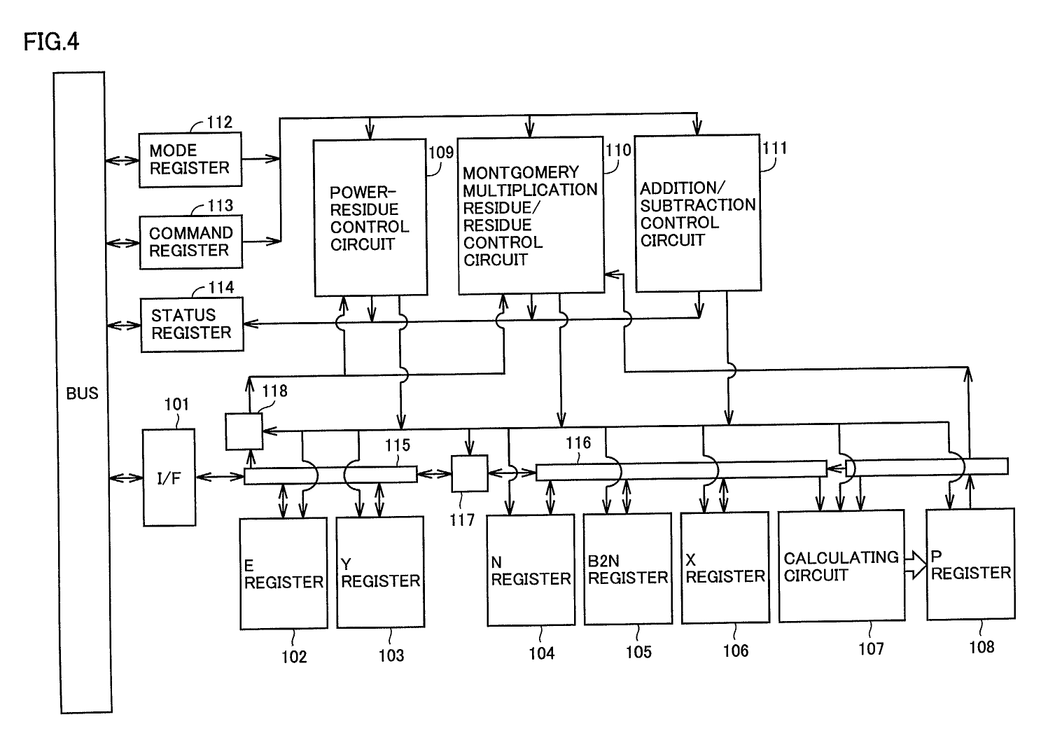

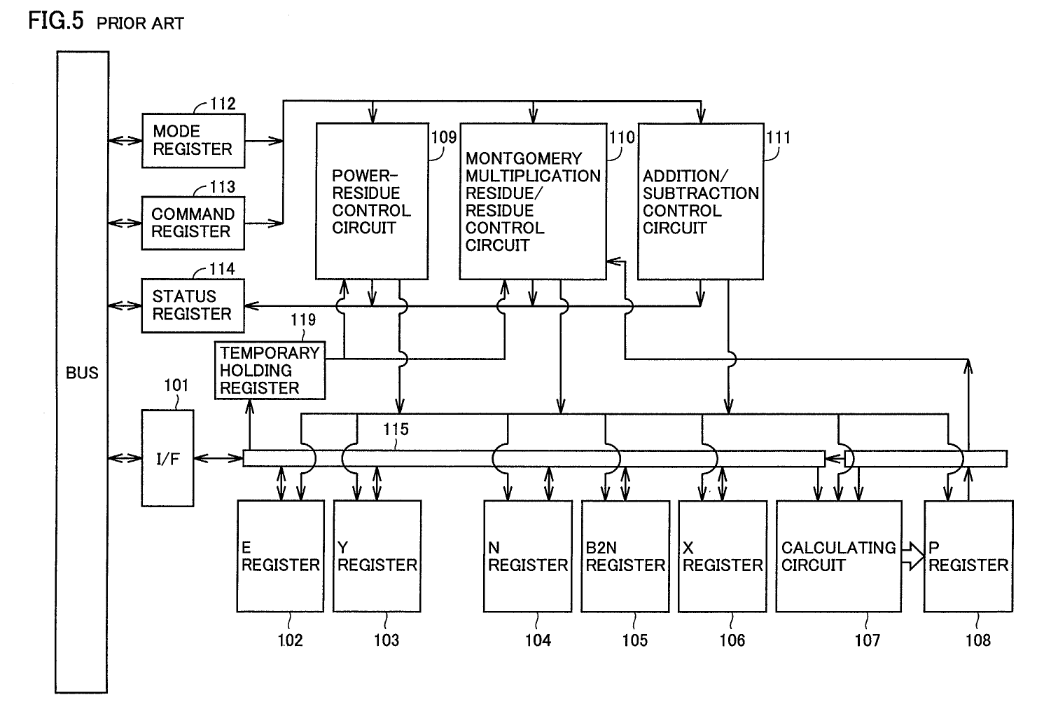

Referring to FIG. 4, a power-residue calculating unit in accordance with a second embodiment of the present invention includes a one-bit selecting circuit 118 provided between internal bus 115 and power-residue control circuit 109 and Montgomery multiplication residue/residue control circuit 110 in the hardware structure of the power-residue calculating unit in accordance with the first embodiment described above with reference to FIG. 1. The other components are similar to those of the first embodiment and therefore the detailed description thereof is not repeated here.

Furthermore, power-residue control circuit 109 and Montgomery multiplication residue/residue control circuit 110 are provided with their respective counters. These counters are similar to those illustrated in the first embodiment, and therefore the detailed description thereof is not repeated here.

(Power-Residue Calculation Process)

Difference between the power-residue calculation process of the present embodiment and that of the first embodiment will be described below.

When the loop of equations (12) and (13) is executed, key e held in e register 102 is read out onto internal bus 115. Accordingly, power-residue control circuit 109 indicates bit j to be read of key e to one-bit selecting circuit 118 depending on the state of the counter of its own. One-bit selecting circuit 118 reads j-th bit value ej of key e, which has been read out onto internal bus 115, and then applies that bit value to power-residue control circuit 109.

When the loop of equations (19)-(21) is executed, multiplier Y held in Y register 103 (multiplier A in equations (19)-(21)) is shifted one bit to the right in accordance with equation (21). Then, j-th bit value Yⱼ (Aⱼ) of multiplier Y corresponds to Amod2 in equation (20). Therefore, when the loop of equations (19)-(21) is executed, multiplier Y held in Y register 103 is read out onto internal bus 115. Accordingly, Montgomery multiplication residue/residue control circuit 110 indicates bit j to be read of multiplier Y to one-bit selecting circuit 118 depending on the state of the counter of its own. One-bit selecting circuit 118 reads j-th bit value Yⱼ of multiplier Y, which has been read out onto internal bus 115, and then applies that bit value to Montgomery multiplication residue/residue control circuit 110.

As described above, in accordance with the present embodiment, internal bus 115 is used only for e register 102 and Y register 103. Therefore, with key e held in e register 102 and multiplier Y held in Y register 103 still being read out on internal bus 115, power-residue control circuit 109 or Montgomery multiplication residue/residue control circuit 110 specifies a bit. Then, one-bit selecting circuit 118 can read a corresponding bit data from internal bus 115 and supply the data to power-residue control circuit 109 or Montgomery multiplication residue/residue control circuit 110.

Therefore, it is unnecessary for power-residue control circuit 109 or Montgomery multiplication residue/residue control circuit 110 to control readout of data held in e register 102 or Y register 103 bit by bit. This can simplify the hardware structure of the power-residue calculating circuit and reduce the circuit scale.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A power-residue calculating unit, comprising:
a first register group holding a first kind of data;
a second register group holding a kind of data to be referred to concurrently with the data held in said first register group;
a first internal bus connected to said first register group;
a second internal bus connected to said second register group;
a Montgomery multiplication residue calculation executing portion connected to said first and second internal buses for concurrently referring to the data held in said first and second register groups and executing a Montgomery multiplication residue calculation; and
a power-residue calculation executing portion connected to said first and second internal buses and said Montgomery multiplication residue calculation executing portion for concurrently referring to the data held in said first and second register groups, communicating data with said Montgomery multiplication residue calculation executing portion, and executing a power-residue calculation.

2. The power-residue calculating unit according to claim 1, wherein
the first kind of data held in said first register group is referred to bit by bit,
said power-residue calculating unit further comprising a one-bit selecting circuit connected to said first internal bus, said Montgomery multiplication residue calculation executing portion and said power-residue calculation executing portion, for acquiring from said first internal bus a bit data determined based on a signal supplied from said Montgomery multiplication residue calculation executing portion or said power-residue calculation executing potion, and then supplying the bit data to said Montgomery multiplication residue calculation executing portion or said power-residue calculation executing portion.

3. The power-residue calculating unit according to claim 2, wherein
said Montgomery multiplication residue calculation executing portion has a counter of which count limit can be changed based on an externally supplied mode signal.

4. The power-residue calculating unit according to claim 3, wherein
said power-residue calculation executing portion has a counter of which count limit can be changed based on an externally supplied mode signal.

5. The power-residue calculating unit according to claim 4, wherein
said counter includes a plurality of flip-flops connected in series, and an operation of a part of said plurality of flip-flops stops according to said mode signal.

6. The power-residue calculating unit according to claim 3, wherein
said counter includes a plurality of flip-flops connected in series, and an operation of a part of said plurality of flip-flops stops according to said mode signal.

7. The power-residue calculating unit according to claim 2, wherein
said power-residue calculation executing portion has a counter of which count limit can be changed based on an externally supplied mode signal.

8. The power-residue calculating unit according to claim 7, wherein
said counter includes a plurality of flip-flops connected in series, and an operation of a part of said plurality of flip-flops stops according to said mode signal.

9. The power-residue calculating unit according to claim 1, wherein
said Montgomery multiplication residue calculation executing portion has a counter of which count limit can be changed based on an externally supplied mode signal.

10. The power-residue calculating unit according to claim 9, wherein
said power-residue calculation executing portion has a counter of which count limit can be changed based on an externally supplied mode signal.

11. The power-residue calculating unit according to claim 10, wherein
said counter includes a plurality of flip-flops connected in series, and an operation of a part of said plurality of flip-flops stops according to said mode signal.

12. The power-residue calculating unit according to claim 9, wherein
said counter includes a plurality of flip-flops connected in series, and an operation of a part of said plurality of flip-flops stops according to said mode signal.

13. The power-residue calculating unit according to claim 1, wherein
said power-residue calculation executing portion has a counter of which count limit can be changed based on an externally supplied mode signal.

14. The power-residue calculating unit according to claim 13, wherein
said counter includes a plurality of flip-flops connected in series, and an operation of a part of said plurality of flip-flops stops according to said mode signal.
